(19) United States
(12) Patent Application Publication
(10) Pub. No.: US 2025/0180162 A1
(43) Pub. Date: Jun. 5, 2025

(54) SAFETY DEVICE FOR A MACHINE TOOL

(71) Applicant: Altendorf GmbH, Minden (DE)

(72) Inventors: Andreas Neufeld, Minden (DE); Karl-Friedrich Schröder, Minden (DE); Julia Pohle, Minden (DE)

(21) Appl. No.: 18/843,902

(22) PCT Filed: Mar. 3, 2023
(86) PCT No.: PCT/EP2023/055499

§ 371 Date: Sep. 4, 2024

(30) Foreign Application Priority Data
Mar. 4, 2022 (DE) 20 2022 101 212.1

(51) Int. Cl. F16P 3/14; B27B 5/38; B27G 19/02

(52) U.S. Cl. CPC F16P 3/142; B27B 5/38; B27G 19/022

(57) ABSTRACT

The invention relates to a safety device for a machine tool, comprising
a detection device which is designed to detect a potentially hazardous state for a part of the body of a user of the machine tool caused by a component of the machine tool which could cause injury
a safety measure device which is designed to carry out a safety measure by means of which a hazardous state of the user of the machine tool is reduced or avoided by a component of the machine tool,
a control device which is coupled to the detection device and the safety measure device in terms of signal technology and is designed to carry out an evaluation of a potentially hazardous state detected by the detection device on the basis of predetermined criteria and, depending on the evaluation, to trigger the safety measure device to carry out a safety measure,
   characterized in that
   the capture device comprises a head mount for attachment to the user's head and an image capture device attached to the head mount and aligned to perform image capture in the user's field of view, and
   the control device is designed to perform the evaluation on the basis of images captured by the image capture device.

The invention relates to a safety device for a machine tool.

Safety devices for machine tools are intended to prevent injuries to the operator of the machine tool. Such injuries can occur if, starting from a potentially hazardous situation, a part of the operator's body or a component of the machine tool (or both) continues to move, resulting in contact between the component and the part of the body. Cut or crush injuries are typical here, which often occur primarily on one of the user's hands. In other cases, however, a potentially hazardous situation can also result in a component being canted on the workpiece and, as a result, chips or the entire workpiece being accelerated in a direction that could cause injury, thereby injuring other parts of the user's body, such as the eyes.

Various solutions for preventing injuries by means of a safety device on machine tools are already known. These solutions aim, for example, to monitor the movement space around a machine tool, such as an automation robot, by means of image capture and to stop the movements of the robot if a person enters this movement space.

For example, a system is known from US 2002/0170399 A1 in which contact between the skin and the circular saw blade is detected by an electrical conductivity measurement via an electrical voltage applied to the circular saw blade and, as a result, a hazardous state is detected. As a subsequent safety measure after such a signal has been obtained, a pretensioned spring is released and a plastic element is pressed into the cutting edge of the circular saw blade with the released spring force. A safety system is known from WO 2004/101239 in which, in a dangerous situation, the circular saw blade is pulled under the table or the drive is decoupled from the circular saw blade in order to achieve deceleration of the circular saw blade by the workpiece.

A safety device is generally known from U.S. Pat. No. 9,702,916 B2, which is also to be used for circular saws. Hazard detection is carried out by means of a calibration and SNR calculation. When a hazard occurs, the motor is deactivated and a cutting tool locking mechanism is activated simultaneously to stop the circular saw blade.

WO 2017/059 473 A1 discloses a method for detecting human tissue in the vicinity of a tool by means of detecting a periodic change in capacitance.

A safety system for circular saws is already known from US 2016/0 279 754 A9. By way of an enumeration of alternative or additional detection measures and action measures, contact or proximity to the saw blade is described as a detection criterion for a hazardous situation and a saw blade stop and a saw blade lowering as an action measure in the event of a hazardous situation.

A safety system for circular saws is already known from WO 2016/145 157 A1, in which a contact or approach of a part of the body to the saw blade is detected by means of a capacitive measurement. The motor is stopped in the event of approach, but a pyrotechnic braking device is ignited in the event of contact. The hazardous state is detected capacitively.

WO 2015/091 245 A1 describes an optical detection system for detecting skin tones and the calculated approach of body parts to the saw blade. The stopping or lowering of the saw blade is described as a reaction mechanism. A dangerous situation is detected in the form of approaching below a certain distance or exceeding a certain approach speed as a trigger criterion.

A safety system for circular saws is already known from US 2014/0 331 833 A1, which is based on a capacitive measurement and is intended to detect contact or an approach of a part of the body to the saw blade. A stop of the cutting movement of the cutting tool is described as the machine reaction when a hazardous situation occurs. Either the approach or contact of a part of the body with the cutting tool is detected as a hazardous situation.

From US 2014/0 090 948 A1, the determination of a hazardous state when a body part approaches the saw blade by means of temperature detection using infrared is already known. The speed of an object is detected and this detection includes the direction of movement and the rate of movement. Depending on the speed detected in this way, a decision is then made as to whether the drive is deactivated or whether a brake is activated.

WO 2013/046 522 A1 describes the monitoring of a hazardous area by a triple sensor arrangement and the stopping of the saw blade when an object enters this hazardous area. Only objects that reflect electromagnetic waves in a certain way are detected, for example an RFID tag attached to a distal end of the thumb of a work glove. An alarm signal is emitted at the same time as the saw blade stops in the event of a hazardous situation.

WO 2014/164 964 A1 describes the detection of a workpiece, with the detection of the material type of the workpiece, in order to optimize cutting parameters derived from this. The speed of a circular saw blade is then controlled as a function of these parameters. The workpiece is detected by a material sensor with regard to its geometric length in the cutting direction and the speed is reduced at the end of the cut in order to reduce the formation of splinters and the associated risk of injury to the operator.

US 2011/0 226 105 A1 describes various safety devices on circular saws and deals with the detection of a hazardous situation as well as the action to be taken in the event of a hazardous situation. For this purpose, different sensor systems for recognizing hazardous situations are disclosed and different actions are described in order to avoid hazardous situations. These include stopping the saw blade, lowering the saw blade, forming a protective shield around the saw blade (airbag) and acoustic or visual signals. The levers shown in FIG. 16, which are intended to cover the cutting edges of the saw blade in hazardous situations, do not appear to be a reliably effective safety device in technological terms when the tool is engaged in a workpiece.

US 2009/0 301 275 A1 describes the detection of a human body part by means of electromagnetic waves in the wave range of 400 nm-1,500 nm and the avoidance of hazardous situations by covering the saw blade and stopping the saw blade. The document describes the detection of the hand in a hazardous area as the triggering event.

DE 10 2007 062 996 A1 describes a safety device for circular saws that stops or lowers the circular saw blade. The hazardous states are detected by recognizing a body part and its direction of movement in a hazardous area, on the other hand the observation of two different movements and their comparison is described.

DE 10 2008 001 727 A1 basically describes a protective device which describes detection by means of sensors, in particular distance sensors, and an action by lowering the saw blade into a protective position.

DE 10 2009 054 491 A1 describes a safety device for circular saws that is based on the detection of a specific glove worn by the operator. The position of this glove is determined with the aid of the detection of electromagnetic radiation in the UV range and, depending on the entry into a danger zone, the circular saw blade is covered by a protective hood.

DE 20 2010 004 458 U1 describes a safety system in which a sensor system detects body parts in the area of the infeed pre-assembly area. A detection of the hazardous situation carried out according to a criterion is described and, in order to prevent a hazard, a shielding of the circular saw blade or a lowering of the saw blade under the table is described as an action.

DE 20 2011 101 566 U1 describes a rapid lowering device for the circular saw blade to avoid hazardous situations.

DE 20 2019 102 935 U1 discloses a safety device that is also suitable for sliding table saws, for example. A sliding table saw is generally known from EP 2 527 069 A1, DE 20 2009 007 150 U1 or WO 2012/159956 A1. In the safety device described in DE 20 2019 102 935 U1, monitoring is carried out by means of image capture in a danger zone around the circular saw blade of the sliding table saw and, if it is detected that the distance between a user's hand and the circular saw blade is too small, the circular saw blade is lowered under the machine tool table in order to avoid contact with the user's hand. The image is captured by means of an image capture device, which is arranged on a cantilevered arm in a vertical direction above the workpiece support surface.

DE 11 2019 000228 T5 discloses a system comprising a headset with a stereoscopic camera. The headset has one or more ranging sensors and motion sensors, and can perform simultaneous localization and mapping algorithms. These sensors and algorithms allow the system to calculate the overall kinematic motion of a chainsaw and to detect and localize hand gestures to determine a relative position between the chainsaw, a user position, a cutting tool and the workpiece. With this information, the system can also trigger a reactive device when the relative position of the user (including extremities) is within a predetermined exclusion zone of the chainsaw or is approaching that exclusion zone at a speed and proximity above a predetermined threshold. In another embodiment of DE 11 2019 000228 T5, the tool may be a table saw and the reactive device may be alerted by the system to quickly stop a saw blade.

In principle, safety devices of this type can significantly improve the safety of the machine tool user and prevent injuries in certain machine tools in normal use. However, there are still problems in that in special situations, for example unusual machining processes, workpiece shapes or the like, the detection device can reliably detect a potentially hazardous state. In such cases, a precautionary safety measure is often taken and machining of the workpiece with the machine tool cannot then be continued. This is disadvantageous and can lead to the user deactivating the safety device in order to use the machine tool without the active safety device, which then creates a risk of injury as on conventional machine tools without a safety device.

Another disadvantage of previously known solutions is that previously known safety devices are often suitable for certain machine tools, but are not designed to be used on other types of machine tools. In particular, hand-held machine tools, i.e. hand-held tools such as drills, jigsaws, hand-held circular saws or angle grinders, cannot therefore be operated with the previously known safety devices in such a way that a satisfactory reduction in the risk of injury to the user is achieved.

There is therefore a need for a safety device that enables a better reduction of the risk of injury to the user in special situations on stationary machine tools or hand-held machine tools.

According to the invention, this task is solved by a safety device of the type described at the introductory portion, in which the detection device comprises a head mount for attachment to the user's head and an image capture device attached to the head mount, which is aligned to perform image capture in the user's field of vision, and in which the control device is designed to perform the evaluation on the basis of images captured by the image capture device.

The safety device according to the invention basically comprises a detection device, a safety measure device and a control device. The detection device is used to detect a potentially hazardous state for a part of the body of a user of the machine tool due to a component of the machine tool that could cause injury. Such a potentially hazardous state is to be understood as a condition from which an injury to the user can result if operation continues unchanged. The injury may be to a body part such as a hand or an arm. In many cases, the detection device will therefore also detect the part of the body that is at risk of injury and monitor its movement. The risk of injury can emanate from any component of the machine tool, in particular a cutting tool such as a saw blade, in particular a circular saw blade of a machine tool, but other tools such as milling tools, turning tools, drilling tools can also be considered as components that pose a risk of injury, or the risk of injury can emanate from a component such as a clamping or guiding device or crushing components of the machine tool. In many cases, the detection device will also detect the component that poses a risk of injury and will therefore be designed to detect both the body part at risk of injury and the component that poses a risk of injury, thereby enabling the potentially hazardous state to be depicted in an image capture.

The safety measure device is used to carry out a safety measure when a potentially hazardous state has been detected. In the simplest case, such a safety measure can consist of a danger signal that warns the user of the machine tool of the danger visually or acoustically. In many cases, however, an active mechanical measure on the machine tool is also carried out downstream or instead of such a danger signal as a safety measure by the safety measure device, for example braking—possibly to the point of stopping—the component that could cause injury, moving the component that could cause injury to an area in which it is no longer at risk of injury or shielding the component that could cause injury by means of a shielding device in order to prevent contact between the body part and the component. The safety measure device can also carry out several different safety measures according to a hazard catalog, for example in the form of different escalation levels, in order to react appropriately to different hazard levels.

Both the detection device and the safety measure device are signal-coupled to a control device. This signal coupling can be wired or wireless and is used to exchange data between the control device, the detection device and the safety device. The control device can be attached to the head mount itself or can be carried by the user independently of the head mount, for example as a separate control device that is connected to the image capture device by means of a data transmission signal. For example, the control device can be implemented in a smartphone that is coupled to the image capture device by means of a fast signal transmission such as Bluetooth or 5G.

The control device is basically designed to evaluate states detected by the detection device and to recognize a potentially hazardous state from these states. This is preferably done in real time. For this purpose, the control device applies predetermined criteria with which it compares the actual state detected by the detection device. Such criteria can be a predetermined safety distance, but can also be a safety distance dependent on the speed of movement or acceleration or the direction of movement or direction of acceleration of the hand, which is calculated according to predetermined criteria. Furthermore, the control device can include additional predetermined criteria in the evaluation, for example if, in addition to the relative distance, speed and acceleration and their direction between the component posing a risk of injury and the body part, other aspects such as the size or weight of the component posing a risk of injury must also be taken into account. This can be advantageous, for example, in the case of interchangeable tools on a machine tool, or if setting parameters of the component at risk of injury on the machine tool have to be taken into account, such as a distance of different lengths, which can be longer or shorter due to a presetting parameter of the tool (such as a cutting height or similar) until a safe, non-injurious position is reached. Furthermore, criteria related to the user can also be taken into account by the control device, for example whether the user is experienced or inexperienced, and the situation detected by the detection device can then be assessed as potentially hazardous or not, depending on the user, with different predetermined criteria.

If the control device determines that a potentially hazardous situation exists based on the situation detected by the detection device during the assessment, it controls the safety measure device so that it executes a safety measure. The control device can control a single safety measure or, in turn, select a safety measure from several different safety measures that is appropriate for the potential hazardous situation detected and control it. This selection of a suitable safety measure can also be based on predetermined criteria.

According to the invention, the detection device comprises a head mount for attachment to the user's head and an image capture device attached to the head mount, which is aligned to perform image capture in the field of view of the user wearing the head mount. The detection device is therefore designed to detect a potentially hazardous state by means of image capture and the image capture device required for this is arranged on a head mount worn by the user. The image capture device is aligned in such a way that it captures an image in the user's field of vision, i.e. typically an image capture device is attached to the head mount for this purpose, aligned in a straight-ahead viewing direction of the user and has an image capture area that corresponds at least to that which a user captures with his eyes when looking straight ahead. The image capture device can also be aligned and designed in such a way that it captures a larger area than the area captured by the user when looking straight ahead, in order to be able to determine a potentially hazardous state on the basis of the detection of components that could cause injury or parts of the body that are outside the user's actual gaze.

The head mount can be a pair of glasses, for example, to which one or two cameras are attached as an image capture device, for example on the side of the arms of the glasses. Such glasses, also known as data glasses, are then used to capture images in the direction of the face of the wearer of the data glasses. In other embodiments, the head mount can also be designed as a helmet, headband, cap or the like, which is worn on the head by the user and to which the image capture device is attached. This in turn can be one or two cameras, for example two video cameras attached to the side of the helmet or headband. In principle, the detection device designed in this way has the advantage that it captures images in the user's field of vision, i.e. it follows the user's head movements and head movements and is therefore, on the one hand, favorably aligned with a danger zone that the user is observing with his eyes and, on the other hand, allows conclusions to be drawn about the user's direction of gaze, i.e. it also makes it possible to detect when the user turns his head away from the danger zone in a potentially dangerous manner.

In the safety device according to the invention, the control device is designed to carry out the assessment of whether a potentially hazardous situation exists due to the situation detected by the detection device on the basis of the images that are captured by the image capture device on the data goggles. These images can be a single image, but as a rule, successive images are captured by the image capture device in the manner of an ongoing real-time video capture of the current situation and evaluated by the control device to determine whether this indicates a potentially hazardous situation. On the one hand, the recording and evaluation using such consecutive images of a video surveillance system allows monitoring without gaps in time; on the other hand, the consecutive images can be used to record movement speeds, movement accelerations and movement directions of the body part and, if applicable, of the component that could cause injury, thereby allowing a differentiated evaluation of the situation with regard to a potentially hazardous state.

Several advantages are achieved by positioning the image capture device on the head mount. Firstly, in regular use, the image capture device is optimally aligned to the area that is also highly relevant for the assessment of a potentially hazardous state, because the user typically aligns his field of vision to precisely this area while machining a workpiece with the machine tool. The arrangement of the image capture device on the head mount can therefore often achieve better monitoring of the relevant area around the component at risk of injury than if the image capture were carried out with a stationary image capture device arranged on the machine tool. According to the inventors, the often better alignment of the image capture device on the head mount is an advantage which can outweigh the associated disadvantage that neither the alignment nor the capture area of the capture device is predetermined, which would be guaranteed with a stationary mounted image capture device, in many situations and leads to a better function of the safety device. At the same time, the image detection device according to the invention makes it possible to determine whether the user is actually looking at the relevant areas or whether he has turned his head away from the relevant area and therefore could not even recognize a potentially hazardous state, which was not possible with previously known safety devices. The image capture device on the head mount therefore makes it possible to detect such an averted field of vision of the user's field of vision, because in this case the body part and/or the component that could cause injury would not be detectable in the image capture. In such a case, it would be possible to conclude that there is a potential hazard because the user is insufficiently monitoring the processing.

Finally, a further advantage of the safety device according to the invention is that image capture by means of a head mount with image capture device can be used for many machine tools for which previous safety devices could not be used, for example for hand tools, where the user regularly has the relevant area for determining a potentially hazardous state in the field of vision by wearing the head mount with image capture device and therefore this can also be captured by the image capture device and consequently evaluated by the control device.

According to the invention, it was recognized that the safety device according to the invention is not limited to use on machine tools in the narrower sense, but can protect a user from injury in many situations. For example, it is also possible, by means of image capture by the image capture device attached to the head mount and the control device, to use image evaluation to monitor a manual activity of the user or an activity carried out with a hand tool, for example manual activities of an electrician on a switch cabinet. In such applications, objects that could cause injury and are detected by the image capture device can be recognized by the image analysis and a movement of a part of the user's body that could lead to a proximity that could cause injury or contact with these objects can be identified. For example, the stripped end of an electrical cable could be recognized as an object posing a risk of injury by image evaluation and a dangerous approaching movement of the hand of an electrician wearing the head mount with image capture device could be identified as a potentially hazardous state. In such a case, an acoustic or visual warning signal could be emitted as a safety measure, for example, or a safety device could be used to switch off the power supply. For the purposes of the invention, a machine tool is therefore generally to be understood as a device that has a component that poses a risk of injury. Consequently, in general, a vehicle or other moving object, for example, can also be understood as a machine tool in the sense of the invention and, by means of the image evaluation, a potential contact that can arise from the movement of such a vehicle or object and the movement of the user's body part or the user himself is understood as a potentially hazardous state.

According to a first preferred embodiment, the control device is designed to recognize the part of the user's body and the component of the machine tool by means of an image evaluation in the image captured by the image capture device and to trigger the safety measure as a function of this recognition. According to this embodiment, a safety measure is triggered depending on the recognition of an image of the part of the user's body and the component of the machine tool that could cause injury. On the one hand, this dependency can consist of the body part and the component being evaluated with regard to their relative distance, their movement in relation to each other or their acceleration in relation to each other and, if necessary, a potentially hazardous state being recognized and a safety measure being triggered. However, the dependency on the detection can also consist of the fact that if one of the two, either the body part or the endangering component or both, are not detected by the image capture device, a safety measure is triggered because in this case it must be assumed that the user has not aligned his head with the endangering area.

According to a further preferred embodiment, it is provided that the control device is designed in order to determine the hazard parameters by means of an image evaluation.
a distance, or
an approach velocity or
an approach acceleration
between the body part and the component and to trigger the safety measure as a function of one or more of these hazard parameters. The approach velocity and acceleration can be understood as the amount of a movement or relative velocity of the body part or the component or the two relative to each other, and the corresponding amount of an acceleration can also be understood as the approach acceleration. However, the direction of the velocity or acceleration can also be taken into account and consequently the velocity vector component or acceleration vector component can be determined. According to this further development, the control device can determine a distance, an approach velocity or an approach acceleration as relative parameters between the body part and the component and make an assessment from one, two or all three parameters in order to draw conclusions about a potentially hazardous state. Such an assessment makes it possible, in particular if at least the distance and approach speed and preferably also the approach acceleration are included in the assessment, to make a differentiated consideration and, for example, if the body part and component approach each other at a high approach speed and possibly also a high approach acceleration, to carry out the safety measure at a greater distance than if the approach speed and approach acceleration are low and a safety measure would therefore only have to be triggered at a smaller distance between body parts and components. This avoids false triggering and allows experienced users in particular to carry out work with the safety device according to the invention where it is necessary to move the body part to a short distance from a dangerous component.

It is further preferred that the control device is designed to use image evaluation as a hazard parameter
a distance of the body part from the image capture device, or
a distance of the component from the image acquisition device, or
a relative direction of movement of the component and body part in relation to each other, or
a relative acceleration direction of component and body part to each other
and to trigger the safety measure as a function of one or more of these hazard parameters. According to this embodiment, an image evaluation is used to determine a distance of the body part and a distance of the component from the image capture device, and furthermore a relative direction of movement of the component and body part relative to each other and a relative direction of acceleration of the component and body part relative to each other are determined. The direction of movement and the direction of acceleration can also be determined from a direction of movement of the component and body part relative to the image capture device. By determining the distance, the direction of movement, the speed of movement and the acceleration or individual ones of these parameters, a differentiated evaluation can in turn be carried out and a safety measure or a suitable safety measure can be selected and triggered from a catalog of several safety measures on the basis of these evaluations.

It is further preferred that the control device is designed to determine the position, speed and/or acceleration of the component of the machine tool by means of an image evaluation using
data processing with artificial intelligence used in image analysis, or
a visually detectable marking on the tool, or
an input from the operator, or
Position data received from a transmitting device on/in the component

According to this embodiment, the control device works with artificial intelligence, for example, in order to carry out an image evaluation and assessment of the situation with regard to any potential hazardous situation. The use of artificial intelligence can, for example, enable a continuous successive improvement of the image evaluation processes and the evaluation processes of the control device by updating the control device from detected hazardous situations-possibly also by means of corresponding data transmission from detected hazardous situations of other devices—and thereby continuously updating the predetermined criteria. The control device can also be equipped with artificial intelligence in such a way that it adapts its predetermined criteria for evaluation on the basis of stored operating sequences and the hazardous situations that have arisen in order to be able to better evaluate typical processing sequences.

The control device can also preferably be designed to detect a predetermined marking on the component, for example in order to reliably detect a correspondingly marked tool. The marking can be designed as a color marking, engraving or code, for example as a QR code, and can also contain information about the component, for example the weight or its dimensions. Such an image-capturable marking can significantly improve the detection of a dangerous component by the control device from the image data of the image capture devices.

Alternatively or additionally, the control device can also carry out the evaluation in response to an input from the operator, for example the operator can manually mark a hazardous component in an image by such an input and thereby make it known to the control device, which can then carry out the evaluation for a potentially hazardous state by evaluating the image and tracking this marked component.

Finally, the control device can also be designed to carry out the assessment using position data transmitted by a transmitter on the endangering component. For this purpose, an RFID unit can be used on the component, for example, to reliably determine the location or operating parameters of the component or machine tool and incorporate them into the assessment of the situation for a potentially hazardous state.

It is further preferred that the image capture device or the control device is designed to perform an image evaluation in order to determine an image section of the captured image which corresponds to a predetermined field of view or section of the field of view of a user wearing the headgear, in particular a section corresponding to the fovea of the field of vision, and the control device is designed to determine by means of an image evaluation whether the component is located within the image section and to trigger the safety measure device to execute a safety measure if the component is not located within the image section. The predetermined field of view can correspond to the user's field of vision or the user's field of vision, or can correspond to a section thereof. According to this embodiment, the image capture device or the control device captures an image area that corresponds to a predetermined field of view or section of the user's field of view. In particular, this may correspond to the fovea of the field of vision, i.e. the area that a user has approximately in the center of his field of vision and which he can monitor with concentration. The image capture device is therefore aligned to or comprises precisely such an image area, which is also reliably captured by the user when observing with their eyes. Image evaluation can then be used to determine whether the hazardous component is located within this image section. In this case, it is ensured that when the component is detected in the image section, the user also has the component in his concentrated monitored field of vision and it can then be decided whether a potentially hazardous situation exists or not. However, if the component is not detected within the image section, the situation is to be assessed in such a way that the user is also not safely monitoring the component and in this case, according to this further development, the control device is designed to trigger a safety measure.

Preferably, it can also be provided that an eye tracking device is attached to the head mount and that the image section is determined depending on the direction of the user's gaze determined by means of the eye tracking. By tracking the user's eyes, it is also possible to determine the direction in which the user's eye is currently looking, for example whether the user is not looking straight ahead but to the side. On the one hand, this makes it possible to determine whether the user, although his head is aligned so that the central, straight-ahead line of vision is directed towards the hazardous component, is deviating from this main axis through his gaze and therefore does not have the component in his line of vision, from which in turn a potentially hazardous state could be derived and a safety measure could be triggered.

According to a further preferred embodiment, it is provided that the safety measure comprises
a reduction in the speed of movement of the component,
a movement of the component into a position with less danger,
shielding of the component, and/or
activation of a warning signal in a signal output device located on the head mount.

In principle, these four different categories of safety measures are possible in order to prevent injury to the user or to reduce the probability of injury. In principle, a reduction in the speed of movement of the component can consist of a deceleration of a translational or rotational movement of the component, with which the component changes location, or a reduction in the speed of rotation of the component when the axis of rotation is stationary; in particular, the reduction can consist of a rapid stop of the movement of the component.

The safety measure can also consist of moving the component from a hazardous position to a non-hazardous position, for example lowering it under a table or moving it into a shield or away from the workpiece. Alternatively or additionally, the component can also be shielded, for example by moving a separating grid, a deflector or the like, in order to prevent the body part from coming into contact with the component and being injured as a result. Finally, a warning signal can also be activated in a signal output device arranged on the head mount, for example a warning light can be projected into the user's eye or a message can be displayed to the user's eye via the signal output device, which indicates a hazardous situation by means of an augmented reality, for example by marking a hazardous component with a signal color projected into the user's eye by the signal output device, or by indicating an insufficient safety distance by means of a display projected into the distance or the component.

It is further preferred that the control device is designed to distinguish between a low and a higher hazard level and to carry out a first safety measure, in particular a warning signal, at the low hazard level and to carry out a second safety measure, which is different from the first safety measure, at the higher hazard level. According to this embodiment, the control device can carry out differentiated safety measures that are triggered depending on a higher or lower hazard level. In this way, the user is enabled to carry out the machining operation even though he has already reached a low hazard level by signaling to the user that he should carry out the machining operation with increased caution, reduced speed or the like in order not to move from the lower hazard level to a higher hazard level, which would then trigger a safety measure with which the machining operation is aborted. For example, the first safety measure can consist of a warning signal, such as an acoustic or visual warning signal, or a slight reduction in the speed of movement of the component, which gives the user a corresponding signal without interrupting the machining of the workpiece. Only with the second safety measure is a processing-interrupting measure taken, such as stopping the movement of the component completely or moving the component to a safe position.

It is further preferred that the control device is arranged on the head mount and the head mount furthermore has a signal transmission unit for wireless signal transmission and is signal-technically coupled to the safety measure device by means of this signal transmission unit. With such a signal transmission unit, the head mount can be worn comfortably by the user and the data determined by the control device on the head mount and in particular the data content for triggering a safety measure can be transmitted to the safety measure device.

Alternatively, it is envisaged that the control device is arranged on the machine tool and the head mount also has a signal transmission unit for wireless signal transmission and is coupled to the control device by means of this signal transmission unit. According to this embodiment, the control device is not arranged on the head mount, but on the machine tool, and in this case the data captured by the image capture device on the head mount is transmitted to the control device by the signal transmission unit.

In principle, in addition to these two options for arranging the control device on the head mount or on the machine tool, another configuration is also advantageous in certain embodiments, in which the control device comprises
a first control unit arranged on the head mount and
a second control unit arranged on the machine tool,
and the head mount furthermore has a signal transmission unit for wireless signal transmission and the first and second control units are coupled in terms of signal technology by means of this signal transmission unit, wherein the first control unit is designed to carry out a first part of the evaluation and to transmit a result determined therefrom to the second control unit, and the second control unit is designed to carry out a second part of the evaluation on the basis of this determined result and to trigger the safety measure device to carry out a safety measure as a function of the evaluation. In this case, the evaluation of the situation recorded by the image capture device for a potentially hazardous state is carried out by a first control unit of a head mount and a second control unit on the machine tool. Splitting the evaluation in this way makes it possible to carry out those parts of the evaluation on the head mount that lead to a reduction in the data to be transmitted, so that an efficient evaluation can be carried out in real time.

It is further preferred if the head mount is designed as a pair of goggles and is designed to be used as protective goggles against mechanical injuries to the eye and/or to compensate for a visual defect of the user. According to this embodiment, the data goggles fulfill additional functions that are necessary for the user personally or in certain work situations. For example, the data goggles can be designed as approved protective goggles against eye injuries or they can be provided with corrective lenses to compensate for the user's personal visual defects.

It is even more preferred if the image capture device on the data goggles is designed to capture images with depth information, in particular in that
the image capture device is designed to capture runtime information on image content or
the image capture device is designed to determine depth information from two images captured at different times and with different capture directions by evaluating the position of recognized objects in relation to one another, or by
the image acquisition device comprises a first and a second image acquisition unit, which are arranged at a distance from each other, for example attached to the head mount on the left and right side of the user's head, and is designed to determine depth information from a stereoscopic image evaluation of simultaneously acquired images of the first and second image evaluation unit.

According to this embodiment, the image capture device is designed to capture depth information about the objects that are captured in an image, thereby enabling a distance of these objects from the image capture device to be determined. This depth information can be provided point by point for each captured pixel or object by object. In principle, various configurations are possible for such depth information acquisition, for example using time-of-flight information of the signal from an object to the image acquisition device, or by using a single image acquisition device to acquire two images with a time offset and using a comparison of objects that were acquired in both images, but which have a different position due to a movement of the image acquisition device between the two images with a time offset, to determine depth information. Furthermore, stereoscopic depth information can also be determined if two image capture units are arranged on the head mount at a distance from each other, which have an at least partially overlapping image capture area and form the image capture device. Using an object that is captured simultaneously by both image capture units, depth information can then be calculated stereoscopically from the angular position of the object in each of the two image capture areas.

It is further preferred if the head mount further comprises an image output device for outputting image and text information into one or both eyes of the user wearing the head mount, in particular by means of
Reproduction of image and text information on a screen, or
Projection of image and text information onto the retina of one or both eyes of the user.

According to this embodiment, the head mount is also equipped to output an image that is seen by the user, for example via a screen arranged on the head mount or via a corresponding projection onto the retina of both eyes of the user. On the one hand, this makes it possible to output simple or differentiated warning signals to the user via the head mount. On the other hand, additional information that is not related to a hazardous situation can be displayed to the user via the image output device.

It is particularly preferred if the head mount has a data interface for data transmission, in particular a data transmission unit for wireless data transmission, and is designed to receive image and/or text information via the data interface and to reproduce it on the image output device, comprising
a sequence of predetermined work sequences for processing a workpiece
a representation of predetermined alignments and/or movements of a tool or a workpiece for carrying out a machining step
a designation of machined workpieces before and/or after machining,
wherein preferably the image or text information is reproduced on the basis of the image capture with the image capture device and an image evaluation performed therefrom to determine the position of the tool or the workpiece in an area which is assigned to the tool or the workpiece in the user's field of vision. This embodiment also uses the head mount for the targeted location-related output of information to the user that is helpful for the machining of a workpiece, for example, a workpiece on which several machining steps must be carried out with the machine tool can be displayed to the user with regard to the necessary alignments and movements of the workpiece or the tool via the image output device on the head mount and a sequence of the machining steps to be carried out one after the other can be displayed as predetermined work sequences. Furthermore, workpieces that are produced in the process can be designated to the user accordingly via the image output device on the head mount, for example as finished parts that the user should specifically set aside or as intermediate finished parts that still require further processing or as remnants.

This information can be provided in the form of images or text, whereby the image or text information is preferably displayed to the user in such a way that he can see it in the respective workpiece in the manner of an augmented reality and can therefore clearly assign it for processing. In principle, it should be understood that in an alternative embodiment, these spatially resolved display functions of the image output device on the head mount can also be implemented without the image capture device arranged on the head mount.

A further aspect of the invention is a machine tool comprising a safety device of the type described above. This machine tool can be a stationary machine tool or a hand tool as described above.

It is particularly preferred if the machine tool is a sliding table saw and the safety device is designed to brake the rotation of a circular saw blade of the sliding table saw and/or to move the circular saw blade of the sliding table saw transversely to its axis of rotation into a non-hazardous position. The safety device according to the invention is suitable for various machine tools, including in particular circular saws, which pose a potential hazard to a user's hand from the circular saw blade and in which the user regularly has his gaze directed towards this hazard area around the circular saw blade during machining. The safety measure for a circular saw can consist of stopping the rotation of the circular saw blade and thereby preventing a cutting injury or moving the circular saw blade of the circular saw that protrudes from a workpiece support surface (e.g. lowering it downwards) so that it lies under this workpiece support surface or within a protective shield and can therefore no longer be reached by a user's hand.

Alternatively, the machine tool can also be designed as a hand tool and the control device is preferably designed to determine an orientation and position of the hand tool in relation to a body part of the user on the basis of an image evaluation of an image captured by the image capture device and to evaluate a potentially hazardous situation of the body part on the basis of the orientation and position, and wherein further preferably the head mount has a data interface, in particular a wireless data transmission device, and is designed to trigger the safety measure device for executing a safety measure as a function of the evaluation via the data interface. This design also makes it possible to monitor hand tools with regard to potentially hazardous states, whereby the image evaluation by the control device also takes into account the fact that the hand tool is guided by the user and can therefore be arranged in very different orientations and distances from the user.

A further aspect of the invention is a head mount for a safety device of the type described above, which is characterized by an image acquisition device which is aligned to perform image acquisition in the field of view of the wearer of the head mount, and preferably further comprising a control device which is coupled to the image acquisition device in terms of signal technology and is designed in order to carry out an evaluation of a potentially hazardous state detected by the image capture device on the basis of predetermined criteria, wherein further preferably the head mount has a data interface, in particular a wireless data transmission device, and is designed in order to control the safety measure device for executing a safety measure as a function of the evaluation via the data interface.

The head mount according to the invention is particularly suitable for use with a safety device or a machine tool of the type described above and can therefore be further developed with regard to the control device and its configuration as well as the image acquisition device arranged thereon in the same way as described above for the safety device according to the invention with the head mount contained therein.

According to the invention, it is therefore also possible to use a head mount with an image capture device arranged thereon for detecting a potentially hazardous state on machine tools, whereby this includes machine tools of the type described above, i.e. stationary, installed machine tools or hand tools.

Finally, a further aspect of the invention is a method for preventing injuries on machine tools, comprising
Detection of a potentially hazardous state for a body part of a user of the machine tool by a component of the machine tool that could cause injury by means of a detection device,
Execution of a safety measure by which a hazardous state of the user of the machine tool is reduced or avoided by a component of the machine tool by means of a safety measure device,
Evaluation of a potentially hazardous state detected by the detection device on the basis of predetermined criteria by means of a control device/device which is coupled to the detection device and the safety measure device by means of signal technology, and
Triggering the safety measure device to execute a safety measure depending on the evaluation,
characterized in that the detection of the potentially hazardous state is performed by means of an image capture device arranged on a head mount, which is aligned to perform image capture in the field of vision of the wearer of the head mount, and the evaluation is performed on the basis of images captured by the image capture device.

With regard to this method for preventing injuries on machine tools, it should be understood that this is carried out according to the principle as previously described for the safety device according to the invention and the method can accordingly also be further developed in the same way as previously explained for the safety device. The method can preferably be carried out with a safety device or a machine tool of the type described above.

A preferred embodiment of the invention is explained with reference to the accompanying figures. These show:

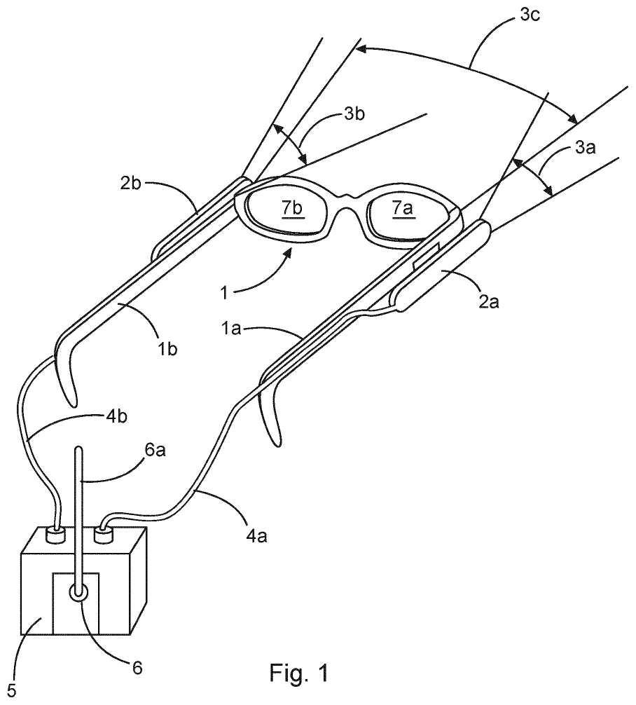

FIG. 1a a schematic, perspective view of a head mount designed as data goggles according to the invention, and

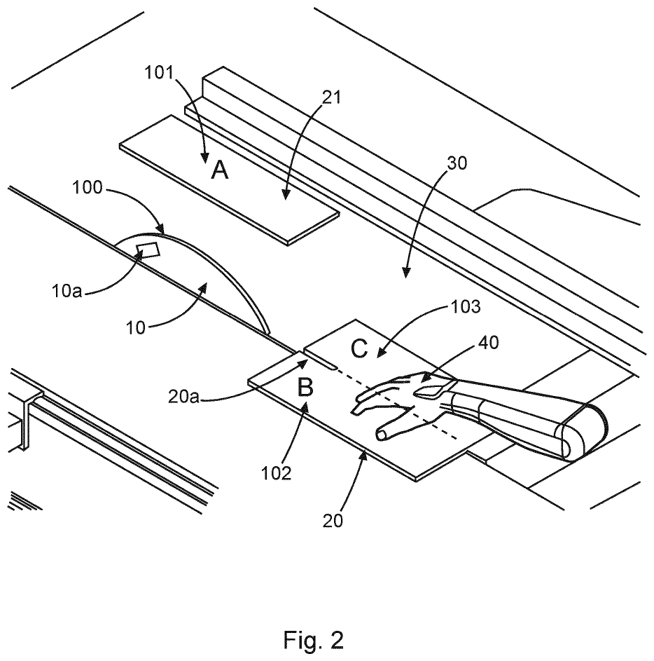

FIG. 2a a schematic representation of a visualization of a machining situation on a machine tool equipped with the safety device according to the invention by means of an image output device on the head mount.

As can first be seen from FIG. 1, a pair of data spectacles for use according to the invention comprises a spectacle frame 1, which basically consists of two temples 1a, 1b and the frame for the two spectacle lenses in a known manner. A video camera 2a, 2b, which form the image capture device, is arranged on the right temple 1a and on the left temple 1b of the spectacle frame 1. As indicated by the image angle 3a, 3b in the figure, these video cameras are aligned approximately with their image recording direction in the longitudinal axis of the temples of the spectacles and thus capture an image area in which the user's field of vision 3c lies. The two video cameras 2a, 2b are connected to a control device 5 via data lines 4a, 4b. The control device 5 comprises a transmission unit 6 with a transmission antenna 6a in order to wirelessly transmit data calculated in the control device from the image data of the two video cameras 2a, 2b to a security measure device.

Projection screens 7a, 7b are inserted into the frame of the spectacle frame, which make it possible to generate an image on the user's retina. These screens 7a, 7b are transparent so that the user can also see through them and the projected image is superimposed on the real environment seen through the glasses to form an augmented reality. The projection can therefore be used to specifically indicate objects that the user sees in the environment through the glass or to superimpose warnings onto the real image of the environment.

FIG. 2 shows an exemplary superimposed image situation designed as augmented reality, which a user sees through the data glasses according to the invention. It can be seen that the user is feeding a workpiece 20 with his hand 40 in the direction of a circular saw blade of a sliding table saw in order to make a cut on the workpiece. The cutting line in the workpiece is projected into the workpiece 20 as an interrupted line 20a by being superimposed on the user via the data goggles. Furthermore, two indications 102 and 103 are shown on the workpiece, which indicate the two workpieces produced after separation by means of the circular saw blade to the user for further handling. These indications 102, 103 can, for example, be a designation of a finished part, such as a door, floor or the like, or can indicate to the user that this part still requires further processing or is a remnant.

The user can also see his own hand 40 through the lens, with which he is guiding the workpiece 20. Furthermore, a workpiece 21 is depicted on the machine tool table 30, in which a further designation 101 is depicted by means of the data goggles. This workpiece is intended for subsequent machining and is marked accordingly using the designation 101.

In the processing situation illustrated in FIG. 2, the user is slowly guiding the workpiece towards the circular saw blade 10 with his hand and the control device has determined both the speed of movement and the direction and acceleration of movement of the hand 40 in the captured image by evaluating several consecutive images. Furthermore, the control device has used the images captured by the video cameras 2a, 2b to detect the circular saw blade 10 and a marking 10a arranged thereon by image evaluation, which contains information on the saw blade diameter and saw blade weight. The direction of movement of the hand and the speed of movement of the hand can therefore be used to determine whether the user's hand is at risk of injury from contact with the saw blade if the movement is continued and at what point in time this contact would occur if the hand movement is continued.

In the present case, the control device has also determined that the hand 40 is currently moving at a slow speed without further acceleration, but exactly in the direction of the circular saw blade, and therefore a potentially hazardous situation with a still low hazard level prevails. A safety measure is therefore triggered via the control device, which in the present case consists of the circular saw blade being provided with a red color marking 100 via the image projection of the data goggles. This color marking 100 can be displayed as constantly illuminated or flashing, with the flashing frequency preferably increasing as the hand 40 moves closer to the circular saw blade in order to signal the increase in the hazardous state.

Using the ongoing image evaluation of the image captured by the video cameras 2a, 2b, the control device can then determine whether the user changes the position and movement of his hand as a result of this first safety measure and thereby removes his hand from the potentially hazardous situation. If the user does this and, for example, removes his hand from the workpiece and pushes the workpiece further with a push stick, the first safety measure can be withdrawn and the red light or flashing of the circular saw blade can be stopped by means of the projection via the data goggles.

However, if the user does not change his hand position in such a way that the potentially hazardous situation is resolved, a situation occurs in which the hand has approached the circular saw blade to a critical distance. On the one hand, this critical distance can be achieved by approaching the hand at a constant speed up to a critical distance. If the control device detects from the images captured in real time by the video cameras that the hand is accelerating and its speed increases as a result, the distance at which a second safety measure is triggered can also increase as a result. If the distance that is calculated as the hazard distance for a second safety measure in relation to the respective direction of movement, speed of movement and, if applicable, acceleration of movement of the hand in relation to the circular saw blade is reached, the control device triggers a second safety measure, which can, for example, consist of the speed of the circular saw blade being reduced by 50%. This second safety measure is very clearly perceived by the user and, although it does not yet lead to an interruption of the processing, it often causes the user to immediately change their working method in order to resolve the potentially hazardous situation and to be able to continue processing the workpiece in the normal way.

If the user does not react to this second safety measure either and continues to move his hand closer to the circular saw blade, a third safety measure is triggered when the distance falls below a third safety distance, which consists of a rapid lowering of the circular saw blade below the workpiece support surface 30. This rapid lowering interrupts the machining process on the workpiece and the circular saw blade is lowered through a saw blade slot in the workpiece support surface 30 of the machine tool in such a way that the user's hand can no longer touch the saw blade, thus preventing injury.

### LIST OF REFERENCE SYMBOLS

1 Spectacle frame
1a, 1b temple
2a, 2b Video camera
3a, 3b Image angle
3c Field of view
4a, 4b Data lines
5 Control device
6 Transmission unit
6a Transmission antenna
7a, 7b Projection screens
10 Circular saw blade
10a Marking by image evaluation
20, 21 Workpiece
20a interrupted line
30 Machine tool table/tool support surface
40 Hand
100 Color coding
101 Designation using the data glasses
102, 103 Two details of the workpiece

1. A safety device for a machine tool, comprising
a detection device which is designed to detect a potentially hazardous state for a part of the body of a user of the machine tool caused by a component of the machine tool which may cause injury
a safety measure device which is designed to carry out a safety measure by means of which a hazardous state of the user of the machine tool is reduced or avoided by a component of the machine tool,
a control device which is coupled to the detection device and the safety measure device in terms of signal technology and is designed to carry out an evaluation of a potentially hazardous state detected by the detection device on the basis of predetermined criteria and, depending on the evaluation, to trigger the safety measure device to carry out a safety measure,
characterized in that
the detection device comprises a head mount for attachment to the user's head and an image capture device attached to the head mount and aligned to perform image capture in the user's field of view, and
the control device is designed to perform the evaluation on the basis of images captured by the image capture device.

2. The safety device according to claim 1,
characterized in that the control device is designed to detect the part of the user's body and the component of the machine tool by means of an image evaluation in the image captured by the image capture device and to trigger the safety measure as a function of this detection.

3. The safety device according to claim 1 or 2,
characterized in that the control device is designed in order to determine, by means of an image evaluation
a distance, or
an approach velocity or
an approach acceleration
between the body part and the component as a hazard parameter and to trigger the safety measure depending on one or more of these hazard parameters.

4. The safety device according to claim 2 or 3,
characterized in that the control device is designed in order to determine, by means of an image evaluation
a distance of the body part from the image capture device, or
a distance of the component from the image capture device, or
a relative direction of movement of the component and body part in relation to each other, or
a relative direction of acceleration of component and body part to each other as a hazard parameter and to trigger the safety measure depending on one or more of these hazard parameters.

5. The safety device according to any of the preceding claims,
characterized in that the control device is designed to determine the position, velocity and/or acceleration of the component of the machine tool by means of an image evaluation using
data processing with artificial intelligence used in image evaluation, or
a visually detectable marking on the tool, or
an input from the operator, or
position data received from a transmitting device on/in the component.

6. The safety device according to any of the preceding claims,
characterized in that the image capture device or the control device is designed to perform an image evaluation in order to determine an image section of the captured image which corresponds to a predetermined field of vision or a predetermined section of the field of vision of a user wearing the data goggles, in particular a section corresponding to the fovea of the field of vision, and the control device is designed to determine by means of an image evaluation whether the component is located within the image section and to trigger the safety measure device to execute a safety measure if the component is not located within the image section.

7. The safety device according to claim 6,
characterized in that an eye-tracking device is attached to the head mount and in that the image section to be evaluated by the image evaluation is determined as a function of the direction of gaze of the user determined by means of the eye-tracking device.

8. The safety device according to any of the preceding claims,
characterized in that the safety measure comprises
a reduction in the speed of movement of the component,
a movement of the component into a position with less danger,
shielding of the component, and/or
an activation of a warning signal in a signal output device arranged on the data goggles.

9. The safety device according to any of the preceding claims,
characterized in that the control device is designed to distinguish between a low and a higher hazard level and to execute a first safety measure, in particular a warning signal, at the low hazard level and to execute a second safety measure, which is different from the first safety measure, at the higher hazard level.

10. The safety device according to any of the preceding claims,
characterized in that the control device is arranged on the head mount and the head mount also has a signal transmission unit for wireless signal transmission and is coupled to the safety measure device by means of this signal transmission unit.

11. The safety device according to any of the preceding claims 1-9,
characterized in that the control device is arranged on the machine tool and the head mount also has a signal transmission unit for wireless signal transmission and is coupled to the control device by means of this signal transmission unit.

12. The safety device according to any of the preceding claims 1-9,
characterized in that the control device comprises
a first control unit arranged on the head mount, and
a second control unit arranged on the machine tool,
and the head mount furthermore has a signal transmission unit for wireless signal transmission and the first and second control units are coupled in terms of signal technology by means of this signal transmission unit,
whereby
the first control unit is designed to carry out a first part of the evaluation and to transmit a result determined therefrom to the second control unit, and
the second control unit is designed to carry out a second part of the evaluation on the basis of this determined result and, depending on the evaluation, to control the safety measure device to carry out a safety measure.

13. The safety device according to any of the preceding claims,
characterized in that the head mount is designed as a pair of goggles and is designed to be used as protective goggles against mechanical injuries to the eye and/or to compensate for a visual defect of the user.

14. The safety device according to any of the preceding claims,
characterized in that the image capturing device is designed to capture images with depth information, in particular by
the image capture device is designed to capture runtime information on image content or
the image capture device is designed to determine depth information from two images captured at different times and with different capture directions on the basis of an image evaluation of the position of recognized objects relative to one another, or by
the image acquisition device comprises a first and a second image acquisition unit which are arranged at a distance from each other, for example attached to the head mount on the left and right side of the user's head, and is designed to determine depth information from a stereoscopic image evaluation of simultaneously acquired images of the first and second image evaluation unit.

15. The safety device according to any of the preceding claims,
characterized in that the head mount further comprises an image output device for outputting image and text information into one or both eyes of the user wearing the head mount, in particular by means of
displaying the image and text information on a screen, or
projection of image and text information onto the retina of one or both eyes of the user.

16. The safety device according to the preceding claim,
characterized in that the head mount has a data interface for data transmission, in particular a data transmission unit for wireless data transmission, and is designed to receive image and/or text information via the data interface and to reproduce it on the image output device, comprising
a sequence of predetermined work sequences for processing a workpiece
a representation of predetermined orientations and/or movements of a tool or workpiece for performing a machining step
a designation of machined workpieces before and/or after machining,
Wherein preferably the image or text information is reproduced on the basis of the image capture with the image capture device and an image evaluation performed therefrom to determine the position of the tool or the workpiece in an area which is assigned to the tool or the workpiece in the user's field of vision.

17. A machine tool comprising a safety device according to any one of the preceding claims.

18. The machine tool according to claim 17, characterized in that the machine tool is a sliding table saw and the safety measure device is designed to brake the rotation of a circular saw blade of the sliding table saw and/or to move the circular saw blade of the sliding table saw transversely to its axis of rotation into a non-hazardous position.

19. The machine tool according to claim 17, characterized in that the machine tool is a hand tool and the control device is preferably designed to determine an orientation and position of the hand tool in relation to a body part of the user on the basis of an image evaluation of an image captured by the image capture device and to evaluate a potentially hazardous situation of the body part on the basis of the orientation and position, and wherein further preferably the data goggles have a data interface, in particular a wireless data transmission device, and are designed to trigger the safety measure device for executing a safety measure as a function of the evaluation via the data interface.

20. A head mount for a safety device according to any one of the preceding claims, characterized by an image acquisition device which is aligned to perform image acquisition in the direction of view of the wearer of the data glasses, and
preferably further comprising a control device (must comprise a cell phone), which is coupled to the image acquisition device in terms of signal technology and is designed to carry out an evaluation of a potentially hazardous state detected by the image acquisition device on the basis of predetermined criteria,
wherein further preferably the head mount has a data interface, in particular a wireless data transmission device, and is designed to trigger the safety measure device for executing a safety measure as a function of the evaluation via the data interface.

21. The head mount according to claim 20,
characterized in that the head mount is formed according to the features of the head mount according to the safety device according to one of the preceding claims 1-19.

22. A method for preventing injuries on machine tools, comprising
Detection of a potentially hazardous state for a body part of a user of the machine tool by a component of the machine tool that could cause injury by means of a detection device,
Execution of a safety measure by which a hazardous state of the user of the machine tool is reduced or avoided by a component of the machine tool by means of a safety measure device,
Evaluation of a potentially hazardous state detected by the detection device on the basis of predetermined criteria by means of a control device/device which is coupled to the detection device and the safety measure device by means of signal technology, and
Triggering the safety measure device to execute a safety measure depending on the evaluation,
characterized in that
the detection of the potentially hazardous state is carried out by means of an image acquisition device arranged on a head mount, which is aligned to carry out image acquisition in the field of vision of the wearer of the head mount, and
the evaluation is carried out on the basis of images captured by the image capture device.
